(19) United States
(12) Patent Application Publication
(10) Pub. No.: US 2018/0233943 A1
(43) Pub. Date: Aug. 16, 2018

(54) POWER SUPPLY SYSTEM FOR VEHICLE

(71) Applicant: Honda Motor Co.,Ltd., Tokyo (JP)

(72) Inventor: Yuki KOIZUMI, Saitama (JP)

(73) Assignee: Honda Motor Co.,Ltd., Tokyo (JP)

(21) Appl. No.: 15/888,097

(22) Filed: Feb. 5, 2018

(30) Foreign Application Priority Data
Feb. 15, 2017 (JP) 2017-026119

(51) Int. Cl. H02J 7/14; H02J 7/16; B60K 6/26; B60W 20/00

(52) U.S. Cl. CPC H02J 7/1423; H02J 7/16; B60K 6/26; B60W 20/00; B60W 2710/244; Y10S 903/906; B60Y 2200/92; B60Y 2300/91; B60K 2006/268

(57) ABSTRACT

A power supply system is provided. The power supply system includes a motor generator capable of performing regenerative power generation when a vehicle decelerates, first and second batteries connected in parallel to the motor generator, a first switch for connecting or disconnecting a first power supply line connecting the second battery and the motor generator to or from the first battery, and a second switch disposed in the first power supply line. An open circuit voltage of the first battery is controlled to be higher than that of the second battery. The power supply system turns on the first and second switches and starts simultaneous charging of the first and second batteries when regenerative power generation is started, and then turns off the first switch and starts preferential charging of the second battery at a timing based on a charging current indicating a charging state of the first battery.

### CROSS REFERENCE TO RELATED APPLICATIONS

This application claims the priority benefit of Japanese Patent Application No. 2017-026119, filed on Feb. 15, 2017. The entirety of the above-mentioned patent application is hereby incorporated by reference herein and made a part of this specification.

### BACKGROUND OF THE INVENTION

### Field of the Invention

The disclosure relates to a power supply system for a vehicle. More particularly, the disclosure relates to a power supply system for a vehicle including a power generator that can generate power while the vehicle is traveling and two storage batteries that are connected to the power generator.

### Description of Related Art

In a power supply system for a vehicle, power generated by a power generator while the vehicle is traveling is stored in a power storage device such as a secondary battery or a capacitor and is supplied to various electric loads (for example, a traveling motor for causing the vehicle to travel or auxiliary machines such as an air conditioner and lights) which are mounted in the vehicle. Recently, a power supply system for a vehicle that includes two or more power storage devices having different characteristics and uses the power storage devices properly depending on a load requiring power has been proposed.

For example, Patent Document 1 discloses a power supply system for a vehicle that includes a lead storage battery and a lithium-ion storage battery having a terminal voltage lower than that of the lead storage battery as two power storage devices having different characteristics. In the power supply system for a vehicle, when a power generator performs regenerative power generation with deceleration of the vehicle, the lead storage battery and the lithium-ion storage battery are connected in parallel to the power generator and the storage batteries are simultaneously charged.

In the power supply system for a vehicle, for example, when a vehicle speed decreases and a generated current of the power generator decreases while the simultaneous charging is being performed, the lead storage battery having a higher potential may be changed from a charging state to a discharging state and an amount of power stored in the lead storage battery is decreased unintentionally even though power generation is performed. At this time, power of the lead storage battery is used to charge the lithium-ion storage battery or to drive another electric load. Therefore, in the power supply system for a vehicle disclosed in Patent Document 1, new discharging of the lead storage battery is prevented by monitoring a discharging state of the lead storage battery while simultaneous charging is being performed and cutting off the lithium-ion storage battery from a charging circuit of the lead storage battery in which the power generator and the lead storage battery are connected depending on the discharging state.

As described above, in the power supply system for a vehicle disclosed in Patent Document 1, the lithium-ion storage battery is cut off from the charging circuit depending on the discharging state of the lead storage battery to be protected in the simultaneous charging such that an unintentional decrease in an amount of power stored in the lead storage battery which has a higher potential and is more likely to discharge among the lead storage battery and the lithium-ion storage battery is prevented. That is, since a timing at which charging of the lithium-ion storage battery ends in the simultaneous charging is determined depending on the discharging state of the lead storage battery regardless of the state of the lithium-ion storage battery, there is concern that the lithium-ion storage battery having a lower potential will not be sufficiently charged and battery performance of the lithium-ion storage battery having high regeneration capability will not be satisfactorily used because discharging of the lead storage battery has been prevented. That is, when the lithium-ion storage battery has a poor state of charge during travel, there is concern that the power generator needs to be driven with an engine to charge the lithium-ion storage battery and thus fuel efficiency of the vehicle as a whole will decrease.
[Patent Document 1] Japanese Patent No. 5889750

### SUMMARY OF THE INVENTION

In one or some of exemplary embodiments of the invention, a power supply system for a vehicle (for example, a power supply system S which will be described later) includes a power generator (for example, a motor generator 1 which will be described later) that is able to perform regenerative power generation when a vehicle decelerates, a first power storage device (for example, a first battery 2 which will be described later) and a second power storage device (for example, a second battery 5 which will be described later) that are connected in parallel to the power generator, and a first switch (for example, a first switch SW1 which will be described later) that connects or disconnects a charging circuit (for example, a first power supply line 34 which will be described later) in which the second power storage device and the power generator are connected to or from the first power storage device, in which an open circuit voltage of the first power storage device is controlled to be higher than an open circuit voltage of the second power storage device. The power supply system includes: a charging control unit (for example, a battery controller 7 which will be described later) configured to turn on the first switch and to start simultaneous charging of the first and second power storage devices when regenerative power generation of the power generator is started; and a first charging state monitoring unit (for example, a battery controller 7 which will be described later) configured to acquire a charging state (for example, a charging current I_Pb and an open circuit voltage V_Pb which will be described later) of the first power storage device while the regenerative power generation is being performed, and the charging control unit turns off the first switch and starts preferential charging of the second power storage device at a timing determined based on the charging state acquired by the first charging state monitoring unit after the simultaneous charging is started.

In one or some of exemplary embodiments of the invention, a power supply system (for example, a power supply system S which will be described later) for a vehicle includes a power generator (for example, a motor generator 1 which will be described later) that is able to perform regenerative power generation when a vehicle decelerates, a first power storage device (for example, a first battery 2 which will be described later) and a second power storage device (for example, a second battery 5 which will be described later) that are connected in parallel to the power generator, and a first switch (for example, a first switch SW1 which will be described later) that connects or disconnects a charging circuit (for example, a first power supply line 34 which will be described later) in which the second power storage device and the power generator are connected to or from the first power storage device, in which an open circuit voltage of the first power storage device is controlled to be higher than an open circuit voltage of the second power storage device. The power supply system includes: a charging control unit (for example, a battery controller 7 which will be described later) configured to start regenerative power generation of the power generator while turning off the first switch and to start preferential charging of the second power storage device; a junction voltage monitoring unit (for example, a battery controller 7 which will be described later) configured to acquire a voltage (for example, a junction voltage VA which will be described later) of a junction (for example, a junction 38 which will be described later) connected to the first power storage device in the charging circuit while the regenerative power generation is being performed; and a first voltage monitoring unit (for example, a battery controller 7 which will be described later) configured to acquire the open circuit voltage (for example, an open circuit voltage V_Pb which will be described later) of the first power storage device while the regenerative power generation is being performed, and the charging control unit turns on the first switch and starts simultaneous charging of the first and second power storage devices at a timing determined based on the voltage of the junction acquired by the junction voltage monitoring unit and the open circuit voltage of the first power storage device acquired by the first voltage monitoring unit after the preferential charging of the second power storage device is started.

### BRIEF DESCRIPTION OF THE DRAWINGS

FIG. 1 is a diagram illustrating a configuration of a power supply system according to a first embodiment of the invention;

FIG. 2 is a diagram illustrating a relationship between a first SOC and an idling stop prohibition SOC;

FIG. 3 is a flowchart illustrating a specific process flow of charging control of first and second batteries at the timing of regenerative power generation;

FIG. 4 is a flowchart illustrating a specific process flow of switch control which is a sub routine of the charging control illustrated in FIG. 3;

FIG. 5 is a flowchart illustrating a specific process flow of switch control in a power supply system according to a second embodiment of the invention;

FIG. 6 is a flowchart illustrating a specific process flow of charging control in a power supply system according to a third embodiment of the invention; and

FIG. 7 is a timing chart of the charging control which is performed by the flowchart illustrated in FIG. 6.

### DESCRIPTION OF THE EMBODIMENTS

In one or some of exemplary embodiments of the invention, a power supply system for a vehicle is provided, which can charge two power storage devices having different terminal voltages with a power generator and prevent the power storage device having a lower voltage from having a poor state of charge.

In one or some of exemplary embodiments of the invention, a power supply system for a vehicle (for example, a power supply system S which will be described later) includes a power generator (for example, a motor generator 1 which will be described later) that is able to perform regenerative power generation when a vehicle decelerates, a first power storage device (for example, a first battery 2 which will be described later) and a second power storage device (for example, a second battery 5 which will be described later) that are connected in parallel to the power generator, and a first switch (for example, a first switch SW1 which will be described later) that connects or disconnects a charging circuit (for example, a first power supply line 34 which will be described later) in which the second power storage device and the power generator are connected to or from the first power storage device, in which an open circuit voltage of the first power storage device is controlled to be higher than an open circuit voltage of the second power storage device. The power supply system includes: a charging control unit (for example, a battery controller 7 which will be described later) configured to turn on the first switch and to start simultaneous charging of the first and second power storage devices when regenerative power generation of the power generator is started; and a first charging state monitoring unit (for example, a battery controller 7 which will be described later) configured to acquire a charging state (for example, a charging current I_Pb and an open circuit voltage V_Pb which will be described later) of the first power storage device while the regenerative power generation is being performed, and the charging control unit turns off the first switch and starts preferential charging of the second power storage device at a timing which is determined based on the charging state acquired by the first charging state monitoring unit after the simultaneous charging is started.

In one or some of exemplary embodiments of the invention, the power supply system may further include: a second charging state monitoring unit (for example, a battery controller 7 which will be described later) configured to acquire a charging state (for example, an open circuit voltage V_LiB which will be described later) of the second power storage device while the regenerative power generation is being performed; and a second switch (for example, a second switch SW2 which will be described later) disposed closer to the second power storage device than a junction (for example, a junction 38 which will be described later) connected to the first power storage device in the charging circuit and configured to connect or disconnect the second power storage device and the power generator, and the charging control unit may start preferential charging of the first power storage device by turning off the second switch at a timing determined based on the charging state acquired by the second charging state monitoring unit and then turning on the first switch after the preferential charging of the second power storage device is started.

In one or some of exemplary embodiments of the invention, the first charging state monitoring unit may acquire a charging current (for example, a charging current I_Pb which will be described later) in the first power storage device while the regenerative power generation is being performed as a parameter indicating the charging state of the first power storage device, and the charging control unit may turn off the first switch and start the preferential charging of the second power storage device when the charging current acquired by the first charging state monitoring unit becomes equal to or less than a predetermined simultaneous charging end current (for example, a simultaneous charging end current I_th which will be described later) after the simultaneous charging is started.

In one or some of exemplary embodiments of the invention, the first charging state monitoring unit may acquire the open circuit voltage (for example, an open circuit voltage V_Pb which will be described later) of the first power storage device as a parameter indicating the charging state of the first power storage device, and the charging control unit may turn off the first switch and start the preferential charging of the second power storage device when a voltage (for example, a junction voltage VA which will be described later) of the junction (for example, a junction 38 which will be described later) connected to the first power storage device in the charging circuit is equal to or lower than the open circuit voltage of the first power storage device acquired by the first charging state monitoring unit after the simultaneous charging is started.

In one or some of exemplary embodiments of the invention, a power supply system (for example, a power supply system S which will be described later) for a vehicle including a power generator (for example, a motor generator 1 which will be described later) that is able to perform regenerative power generation when a vehicle decelerates, a first power storage device (for example, a first battery 2 which will be described later) and a second power storage device (for example, a second battery 5 which will be described later) that are connected in parallel to the power generator, and a first switch (for example, a first switch SW1 which will be described later) that connects or disconnects a charging circuit (for example, a first power supply line 34 which will be described later) in which the second power storage device and the power generator are connected to or from the first power storage device, in which an open circuit voltage of the first power storage device is controlled to be higher than an open circuit voltage of the second power storage device. The power supply system includes: a charging control unit (for example, a battery controller 7 which will be described later) configured to start regenerative power generation of the power generator while turning off the first switch and to start preferential charging of the second power storage device; a junction voltage monitoring unit (for example, a battery controller 7 which will be described later) configured to acquire a voltage (for example, a junction voltage VA which will be described later) of a junction (for example, a junction 38 which will be described later) connected to the first power storage device in the charging circuit while the regenerative power generation is being performed; and a first voltage monitoring unit (for example, a battery controller 7 which will be described later) configured to acquire the open circuit voltage (for example, an open circuit voltage V_Pb which will be described later) of the first power storage device while the regenerative power generation is being performed, and the charging control unit turns on the first switch and starts simultaneous charging of the first and second power storage devices at a timing determined based on the voltage of the junction acquired by the junction voltage monitoring unit and the open circuit voltage of the first power storage device acquired by the first voltage monitoring unit after the preferential charging of the second power storage device is started.

In one or some of exemplary embodiments of the invention, the charging control unit may turn off the first switch when the voltage of the junction acquired by the junction voltage monitoring unit is equal to or lower than the open circuit voltage of the first power storage device acquired by the first voltage monitoring unit while the regenerative power generation is being performed and the first switch is turned off.

In the power supply system for a vehicle according to one or some of exemplary embodiments of the invention, the first and second power storage devices are arranged in parallel to the power generator, the charging circuit of the second power storage device in which the second power storage device and the power generator are connected is connected to the first power storage device via the first switch, and the open circuit voltage of the first power storage device is set to be higher than the open circuit voltage of the second power storage device. In the power supply system for a vehicle, when the regenerative power generation of the power generator is started, the first switch is turned on and the simultaneous charging of the first and second power storage devices is started. Accordingly, a generated current is supplied from the power generator to the first and second power storage devices and thus the first and second power storage devices are simultaneously charged. Here, when the simultaneous charging of the first and second power storage devices is continuously performed as described above, the first power storage device having a higher potential is changed from charging to discharging. In the power supply system for a vehicle according to one or some of exemplary embodiments of the invention, by turning off the first switch at the timing determined based on the charging state of the first power storage device while the simultaneous charging is being performed, the simultaneous charging can be switched to the preferential charging of the second power storage device before the first power storage device is changed from charging to discharging. Accordingly, it is possible to charge the first power storage device to a certain extent while the second power storage device is prevented from having a poor state of charge. Since an opportunity to drive the power generator using an engine while the vehicle is traveling and to forcibly charge the second power storage device can be reduced by preventing the second power storage device from having a poor state of charge, it is possible to improve fuel efficiency of the vehicle as a whole.

In the power supply system for a vehicle according to one or some of exemplary embodiments of the invention, the preferential charging of the first power storage device is started by turning off the second switch and turning on the first switch at the timing which is determined based on the charging state of the second power storage device after the simultaneous charging is switched to the preferential charging of the second power storage device. That is, in the power supply system for a vehicle according to one or some of exemplary embodiments of the invention, the second power storage device is preferentially charged and then the first power storage device is charged when there is room to spare. Accordingly, when the regenerative power generation is prolonged, it is possible to additionally charge the first power storage device while preferentially charging the second power storage device.

The generated current in the regenerative power generation decreases with a decrease in the speed of the vehicle and a decrease in the rotation speed of the power generator. Accordingly, the generated current decreases, the charging current to the first power storage device decreases, and the first power storage device is switched from charging to discharging. Therefore, in the power supply system for a vehicle according to one or some of exemplary embodiments of the invention, when the charging current to the first power storage device becomes equal to or less than the predetermined simultaneous charging end current while the simultaneous charging is being performed, it is possible to minimize discharging of the first power storage device during the regenerative power generation by turning off the first switch.

The generated current in the regenerative power generation decreases with a decrease in the speed of the vehicle and a decrease in the rotation speed of the power generator. Accordingly, the generated current decreases, the voltage of the junction connected to the first power storage device in the charging circuit decreases, and the first power storage device is switched from charging to discharging. Therefore, in the power supply system for a vehicle according to one or some of exemplary embodiments of the invention, when the voltage of the junction becomes equal to or lower than the open circuit voltage of the first power storage device while the simultaneous charging is being performed, it is possible to minimize discharging of the first power storage device during the regenerative power generation by turning off the first switch.

In the power supply system for a vehicle according to one or some of exemplary embodiments of the invention, the first and second power storage devices are arranged in parallel to the power generator, the charging circuit of the second power storage device in which the second power storage device and the power generator are connected is connected to the first power storage device via the first switch, and the open circuit voltage of the first power storage device is set to be higher than the open circuit voltage of the second power storage device. In the power supply system for a vehicle, the regenerative power generation is started while the first switch is turned off and the preferential charging of the second power storage device is started. Accordingly, a generated current is supplied from the power generator to the second power storage device and thus the second power storage device is charged. At this time, the voltage of the junction connected to the first power storage device in the charging circuit of the second power storage device and the open circuit voltage of the first power storage device are acquired, and the first switch is turned on and the simultaneous charging of the first and second power storage devices is performed at the timing determined based on the voltage of the junction while the generated current is supplied to the second power storage device and the open circuit voltage of the first power storage device as described above. In a case in which the first and second power storage devices are connected to the power generator and the simultaneous charging thereof is performed, the first power storage device may not be charged but may be discharged even by turning on the first switch when the generated current from the power generator is small and the voltage of the junction is lower than the open circuit voltage of the first power storage device. In the power supply system for a vehicle according to one or some of exemplary embodiments of the invention, in the regenerative power generation, by preferentially charging the second power storage device and then determining the time at which the simultaneous charging is started using the voltage of the junction and the voltage of the first power storage device, it is possible to start the simultaneous charging while discharging of the first power storage device is prevented. Accordingly, it is possible to charge the first power storage device to a certain extent while the second power storage device is prevented from having a poor state of charge. Since opportunities to drive the power generator using an engine while the vehicle is traveling and to forcibly charge the second power storage device can be reduced by preventing the second power storage device from having a poor state of charge, it is possible to improve fuel efficiency of the vehicle as a whole.

The generated current in the regenerative power generation decreases with a decrease in the speed of the vehicle and a decrease in the rotation speed of the power generator. Accordingly, when the generated current decreases and the voltage of the junction decreases, the first power storage device is switched from charging to discharging. Therefore, in the power supply system for a vehicle according to one or some of exemplary embodiments of the invention, when the voltage of the junction becomes equal to or lower than the open circuit voltage of the first power storage device while the first power storage device is being charged by turning on the first switch, it is possible to minimize discharging of the first power storage device during the regenerative power generation by turning off the first switch.

### First Embodiment

Hereinafter, a first embodiment of the invention will be described with reference to the accompanying drawings.

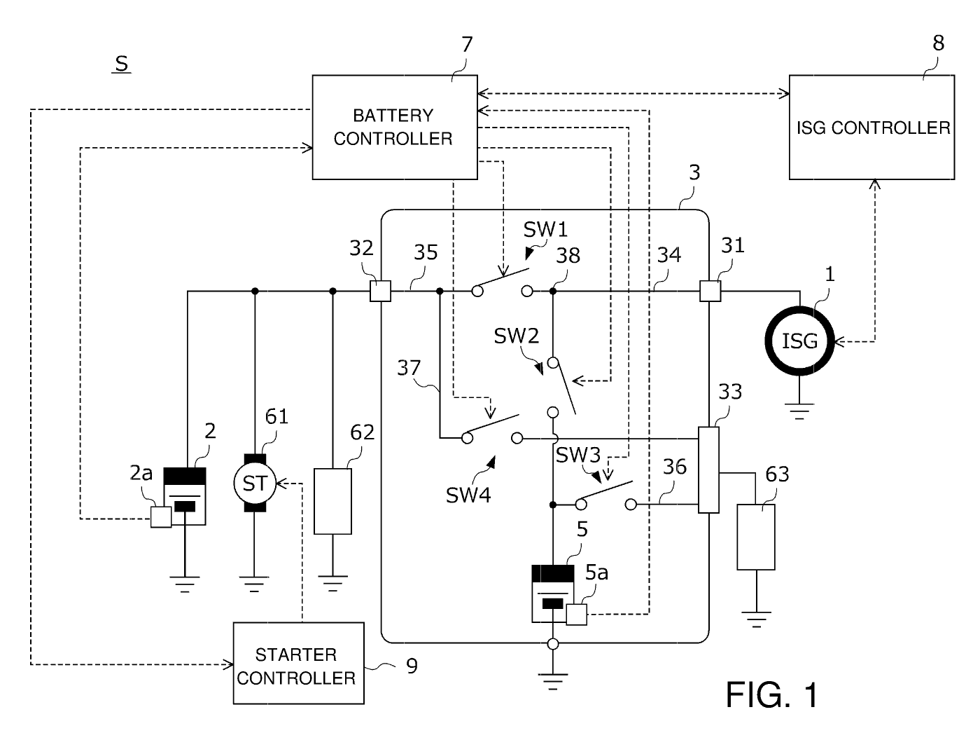

FIG. 1 is a diagram illustrating a configuration of a power supply system S according to this embodiment. The power supply system S is for a vehicle and is mounted in a vehicle which is not illustrated and which includes an engine as a power train. The power supply system S supplies power to various electric loads mounted in the vehicle or is charged with power which is generated using a power generator mounted in the vehicle.

The power supply system S includes a motor generator 1 serving as a power generator, a first battery 2 serving as a first power storage device, a battery module 3 including a second battery 5 serving as a second power storage device, and a battery controller 7 that controls the battery module 3.

The motor generator 1 is connected to a crank shaft of an engine which is not illustrated via a power transmission mechanism such as a belt or a pulley. A motor generator which is called an integrated starter generator (ISG) is used as the motor generator 1. That is, the motor generator 1 functions as a power generator that generates power when it is rotationally driven by the crank shaft and as an electric motor that rotationally drives the crank shaft. The motor generator 1 is connected to a first input/output terminal 31 of the battery module 3 and can rotationally drive the crank shaft using electric power supplied from the battery module 3 or supply electric power generated by the motor generator 1 to the battery module 3.

An ISG controller 8 including an inverter, a regulator, a voltage sensor, a current sensor, and a microcomputer is connected to the motor generator 1 to control a generated voltage or a generated current thereof. When the motor generator 1 serves as a power generator, the ISG controller 8 controls the generated voltage by controlling a current supply state of a coil of the motor generator 1 and controls the generated current by controlling the inverter. The generated current of the motor generator 1 controlled by the ISG controller 8 is supplied to the first battery 2, the second battery 5, a first electric load 62, and a second electric load 63 via the first input/output terminal 31.

The first electric load 62 mainly includes electronic devices which are not essential to cause the vehicle to travel, for example, an audio device, among electronic devices mounted in the vehicle. On the other hand, the second electric load 63 mainly includes electronic devices which are essential to cause the vehicle to travel, for example, a driving device of electric power steering and electronic control units such as the battery controller 7 and the ISG controller 8, among the electronic devices mounted in the vehicle.

The motor generator 1 serving as a power generator can perform two types of power generation including normal power generation and regenerative power generation. The normal power generation means that energy of fuel is converted into electric energy by causing the motor generator 1 to generate electric power using power which is generated by burning fuel in an engine. The regenerative power generation means that kinetic energy of the vehicle is converted into electric energy by causing the motor generator 1 to generate electric power when the vehicle decelerates. When the vehicle decelerates, the ISG controller 8 performs the regenerative power generation using the motor generator 1 and supplies a generated current to the battery module 3. When a power generation request is issued from the battery controller 7, the ISG controller 8 performs the normal power generation using the motor generator 1 and supplies a generated current to the battery module 3.

The first battery 2 is a secondary battery that can perform both of discharging for converting chemical energy into electric energy and charging for converting electric energy into chemical energy. Hereinafter, a case in which a so-called lead storage battery using lead for an electrode is used as the first battery 2 will be described, but the invention is not limited thereto.

The first battery 2 is connected to the motor generator 1 and the second electric load 63 via the battery module 3. More specifically, the first battery 2 is connected to a second input/output terminal 32 of the battery module 3 and can perform charging and discharging with the motor generator 1 via the battery module 3 or discharge power to the second electric load 63 via the battery module 3. A predetermined target is set in a state of charge (which represents a ratio of a residual capacity of a secondary battery to a battery capacity in percentage and which is hereinafter abbreviated to SOC) of the first battery 2. In the power supply system S, charging and discharging of the first battery 2 is controlled such that the SOC of the first battery 2 (hereinafter also referred to as a “first SOC”) is substantially maintained at the target (hereinafter also referred to as a “first target SOC”).

A first sensor unit 2a including a voltage sensor that detects a terminal voltage of the first battery 2, a current sensor that detects a current flowing in the first battery 2, and a temperature sensor that detects a temperature of the first battery 2 is provided in the first battery 2. The first sensor unit 2a transmits detection signals corresponding to the terminal voltage, the current, and the temperature of the first battery 2 to the battery controller 7. An open circuit voltage of the first battery 2, that is, the terminal voltage of the first battery 2 when no current flows in the first battery 2, is estimated by the battery controller 7 based on the detection signals of the first sensor unit 2a using an existing algorithm. The first SOC is estimated by the battery controller 7 by searching a predetermined map using the open circuit voltage of the first battery 2.

A starter 61 and the first electric load 62 are connected to the first battery 2 at a position closer to the first battery 2 than the second input/output terminal 32 of the battery module 3. The starter 61 is connected to the crank shaft of the engine which is not illustrated, and rotationally drives the crank shaft to start the engine when a driving current is supplied from the first battery 2. The starter 61 is connected to a starter controller 9 that controls the driving current.

The starter controller 9 includes a relay unit that connects or disconnects the starter 61 to or from the first battery 2 and a microcomputer that drives the relay unit. The starter controller 9 drives the starter 61 to start the engine by supplying the driving current from the first battery 2 to the starter 61 with an operation of a starter switch (not illustrated) by a driver as a trigger. When a predetermined automatic stopping condition is satisfied while the vehicle is traveling, the starter controller 9 stops the engine which is not illustrated and enters an idling stop state. When a predetermined automatic restarting condition is satisfied in the idling stop state, the starter controller 9 drives the starter 61 to restart the engine by supplying the driving current from the first battery 2 to the starter 61.

Examples of the automatic stopping condition include a condition that a speed of the vehicle is equal to or less than a predetermined value, a condition that an accelerator pedal of the vehicle is not depressed, and a condition that a brake pedal of the vehicle is depressed. Examples of the automatic restarting condition include a condition that the accelerator pedal is depressed, a condition that depression of the brake pedal is released, and a condition that a power generation request which will be described later is issued from the battery controller 7 in the idling stop state.

The battery module 3 includes a first input/output terminal 31, a second input/output terminal 32, an output terminal 33, a first power supply line 34, a second power supply line 35, a third power supply line 36, a fourth power supply line 37, a first switch SW1, a second switch SW2, a third switch SW3, a fourth switch SW4, and the second battery 5.

The first power supply line 34 connects the second battery 5 to the first input/output terminal 31 to which the motor generator 1 is connected. The generated current of the motor generator 1 is supplied to the second battery 5 via the first power supply line 34. That is, the first power supply line 34 constitutes a part of a charging circuit of the second battery 5 with the motor generator 1.

The second power supply line 35 connects the first power supply line 34 to the second input/output terminal 32 to which the first battery 2 is connected. In the following description, a section of the first power supply line 34 connected to the second power supply line 35 is particularly referred to as a junction 38. The generated current of the motor generator 1 is supplied to the first battery 2 via a section from the first input/output terminal 31 to the junction 38 in the first power supply line 34 and the second power supply line 35. That is, the section from the first input/output terminal 31 to the junction 38 in the first power supply line 34 and the second power supply line 35 constitute a part of a charging circuit of the first battery 2 with the motor generator 1. The first battery 2 and the second battery 5 are connected in parallel to the motor generator 1 via the power supply lines 34 and 35.

The second electric load 63 is connected to the output terminal 33. The third power supply line 36 connects the output terminal 33 to a part of the first power supply line 34 closer to the second battery 5 than the junction 38. The second electric load 63 is supplied with the power of the second battery 5 via the third power supply line 36. The fourth power supply line 37 connects the second power supply line 35 to the output terminal 33. Accordingly, the second electric load 63 can be supplied with the power of the first battery 2 as well as the second battery 5 via the fourth power supply line 37 as described above.

The first switch SW1 is disposed closer to the junction 38 than a part of the second power supply line 35 connected to the fourth power supply line 37. The first switch SW1 connects (ON) or disconnects (OFF) the first battery 2 to or from the first power supply line 34 which is the charging circuit of the second battery 5 in accordance with a command signal from the battery controller 7. Accordingly, for example, when the first battery 2 is charged with the motor generator 1 or when the motor generator 1 is driven with the first battery 2, the battery controller 7 turns on the first switch SW1.

The second switch SW2 is disposed between the junction 38 and a part connected to the third power supply line 36 in the first power supply line 34. The second switch SW2 connects (ON) or disconnects (OFF) the second battery 5 to or from the motor generator 1 in accordance with a command signal from the battery controller 7. Accordingly, for example, when the second battery 5 is charged with the motor generator 1 or when the motor generator 1 is driven with the second battery 2, the battery controller 7 turns on the second switch SW2.

The third switch SW3 is provided in the third power supply line 36. The third switch SW3 connects (ON) or disconnects (OFF) the second battery 5 to or from the second electric load 63 in accordance with a command signal from the battery controller 7. Accordingly, for example, the battery controller 7 turns on the third switch SW3 when discharging from the first battery 2 to the second electric load 63 is permitted, and turns off the third switch SW3 when discharging from the first battery 2 to the second electric load 63 is prohibited.

The fourth switch SW4 is provided in the fourth power supply line 37. The fourth switch SW4 connects (ON) or disconnects (OFF) the first battery 2 to or from the second electric load 63 in accordance with a command signal from the battery controller 7. Accordingly, for example, the battery controller 7 turns on the fourth switch SW4 when discharging from the first battery 2 to the second electric load 63 is permitted, and turns off the fourth switch SW4 when discharging from the first battery 2 to the second electric load 63 is prohibited.

As described above, in the battery module 3, a driving power source of the motor generator 1 can be arbitrarily switched between two batteries 2 and 5 using two switches SW1 and SW2, and a driving power source of the second electric load 63 can be arbitrarily switched between two batteries 2 and 5 using two switches SW3 and SW4.

The second battery 5 is a secondary battery that can perform both charging and discharging similarly to the first battery 2. In the following description, a case in which a so-called lithium-ion storage battery that performs charging and discharging by movement of lithium ions between electrodes is used as the second battery 5 will be described, but the invention is not limited thereto. The first battery 2 and the second battery 5 may have different characteristics. More specifically, a storage battery having a higher output density and a larger battery capacity than the first battery 2 can be used as the second battery 5. A predetermined target (hereinafter also referred to as a “second target SOC”) is set for the SOC of the second battery 5 (hereinafter also referred to as a “second SOC”). In the power supply system S, charging and discharging of the second battery 5 is controlled such that the second SOC is substantially maintained at the second target SOC.

A second sensor unit 5a including a voltage sensor that detects a terminal voltage of the second battery 5, a current sensor that detects a current flowing in the second battery 5, and a temperature sensor that detects a temperature of the second battery 5 is provided in the second battery 5. The second sensor unit 5a transmits detection signals corresponding to the terminal voltage, the current, and the temperature of the second battery 5 to the battery controller 7. An open circuit voltage of the second battery 5, that is, the terminal voltage of the second battery 5 when no current flows in the second battery 5, is estimated by the battery controller 7 based on the detection signals of the second sensor unit 5a using an existing algorithm. The second SOC is estimated by the battery controller 7 by searching a predetermined map using the open circuit voltage of the second battery 5.

The battery controller 7 includes a microcomputer that performs various calculations using the detection signals from the sensor units 2a and 5a and the like and a driving circuit that turns on or off four switches SW1 to SW4 of the battery module 3.

The battery controller 7 controls the first SOC and the second SOC by turning on or off the switches SW1 to SW4 depending on a vehicle state or states of the batteries 2 and 5 and controlling charging and discharging of the batteries 2 and 5.

More specifically, the battery controller 7 sequentially estimates the first SOC and the second SOC using the detection signals from the sensor units 2a and 5a, issues a power generation request to the ISG controller 8 and the starter controller 9 such that the first SOC and the second SOC are substantially maintained at the first target SOC and the second target SOC, respectively, and causes the motor generator 1 to perform normal power generation. While the motor generator 1 is performing the normal power generation, the battery controller 7 connects the motor generator 1 to one requiring charging among the two batteries 2 and 5 by turning on or off the switches SW1 and SW2, appropriately charges the batteries 2 and 5, and controls the first SOC and the second SOC.

The open circuit voltages of the batteries 2 and 5 have characteristics that the open circuit voltages change depending on the SOCs thereof. More specifically, the open circuit voltages of the batteries 2 and 5 have characteristics that the open circuit voltages increase as the SOC increases. Therefore, the battery controller 7 sets values of the first target SOC and the second target SOC such that the open circuit voltage of the first battery 2 is maintained at a higher value than the open circuit voltage of the second battery 5 in consideration of the SOC-OCV characteristics (open circuit voltage vs SOC characteristics) of the batteries 2 and 5.

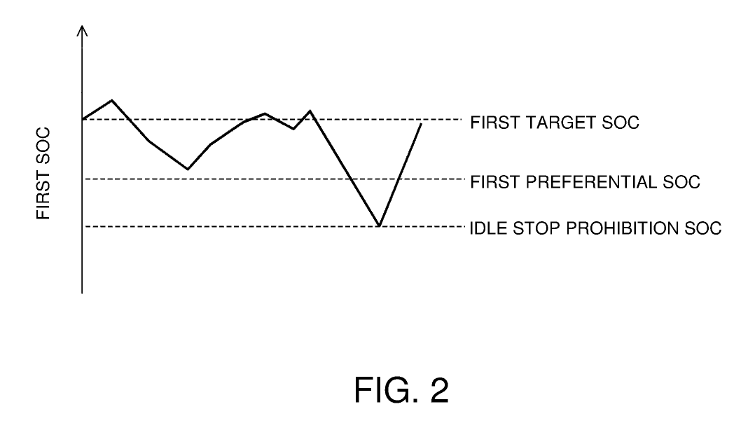

A process flow of issuing a power generation request in the battery controller 7 in the idling stop state will be described below. In the idling stop state, since the engine stops and thus the motor generator 1 cannot generate power, the first battery 2 is not charged and thus the first SOC decreases. The battery controller 7 sequentially estimates the first SOC in the idling stop state, and issues a power generation request to the ISG controller 8 and the starter controller 9 when the first SOC is less than an idling stop prohibition SOC which is set to a value slightly smaller than the first target SOC (see FIG. 2). The starter controller 9 restarts the engine in response to the power generation request. The ISG controller 8 performs normal power generation using the motor generator 1 in response to the power generation request and supplies a generated current to the battery module 3. When the normal power generation of the motor generator 1 is started, the battery controller 7 supplies the generated current of the motor generator 1 to the first battery 2 and increases the first SOC to the first target SOC by turning on the first switch SW1 to connect the motor generator 1 to the first battery 2.

The driving power source of the second electric load 63 including electronic devices required to cause the vehicle to travel can be arbitrarily switched between two batteries 2 and 5 using two switches SW3 and SW4. Since the second battery 5 has a higher output density and a larger battery capacity than the first battery 2 as described above, the second battery 5 has high regeneration capability. Therefore, the battery controller 7 preferentially uses the second battery 5 having high regeneration capability as the driving power source of the second electric load 63 prior to the first battery 2. That is, the battery controller 7 uses the second battery 5 as the driving power source of the second electric load 63 by basically turning on the third switch SW3 and turning off the fourth switch SW4 while the vehicle is traveling, uses the first battery 2 as the driving power source of the second electric load 63 by turning on the fourth switch SW4 and turning off the third switch SW3 when the second SOC decreases to a certain extent.

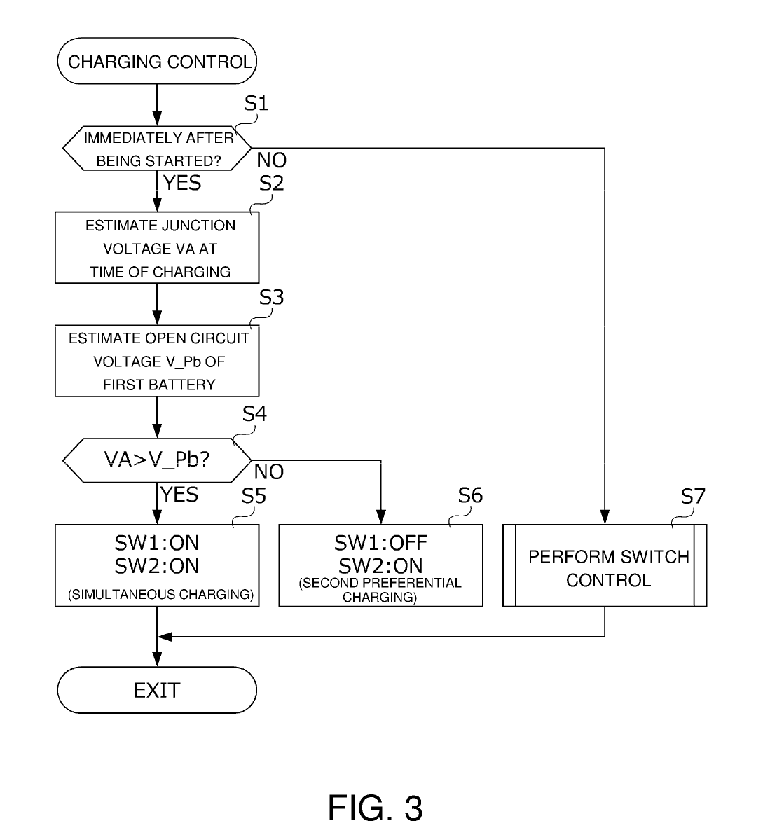

FIG. 3 is a flowchart illustrating a specific process flow of charging control of the first and second batteries when the motor generator performs regenerative power generation. The process flow illustrated in FIG. 3 is repeatedly performed at predetermined control intervals by the battery controller when the traveling vehicle is changed to a decelerating state and the motor generator performs the regenerative power generation accordingly. Immediately after the regenerative power generation is started, it is assumed that both the first and second switches are turned off and both the first and second batteries are disconnected from the motor generator.

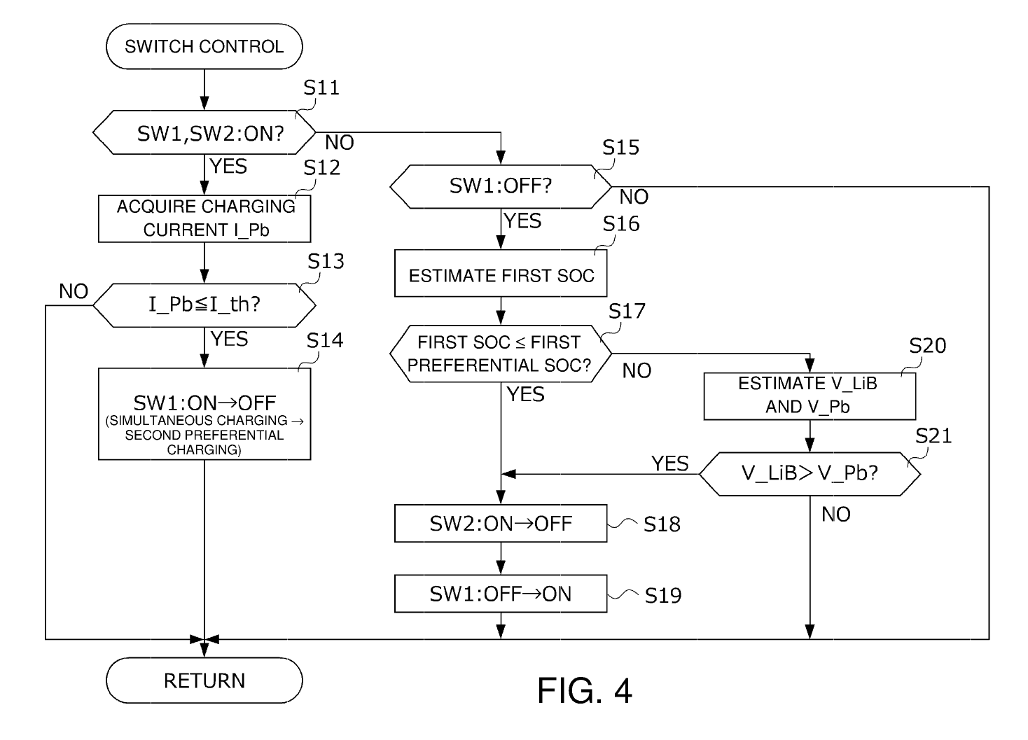

In S1, the battery controller determines whether it is immediately after the regenerative power generation is started. When the determination result of S1 is YES, the battery controller sets initial states of the first and second switches by performing the processes of S2 to S7. When the determination result of S2 is NO, that is, when the processes of S2 to S7 have been already performed and the initial states of the first and second switches has been set, the battery controller performs switch control of switching ON/OFF of the first and second switches (see FIG. 4 which will be described later) in S8.

In S2, the battery controller estimates a voltage VA of the junction. The voltage VA of the junction corresponds to a voltage of the junction while the second battery is being charged when the second switch is turned on and a generated current corresponding to a predetermined target generated current at the timing of the regenerative power generation is supplied from the motor generator to the second battery to charge the second battery. The voltage VA of the junction is calculated by adding a current open circuit voltage V_LiB of the second battery to a value obtained by multiplying the target generated current by a value obtained by adding internal resistance R_LiB of the second battery and other resistance R1 as expressed by Equation (1). Here, the open circuit voltage V_LiB of the second battery can be estimated based on the detected values of the voltage sensor, the current sensor, and the temperature sensor disposed in the second battery using an existing algorithm. For example, a predetermined value is used as the internal resistance R_LiB of the second battery. The other resistance R1 is electric resistance between the junction and the second battery and, for example, a predetermined value is used.

VA=V_LiB+(R_LiB+R1)×target generated current (1)

In S3, the battery controller estimates an open circuit voltage V_Pb of the first battery. Here, the open circuit voltage V_Pb of the first battery can be estimated based on the detected values of the voltage sensor, the current sensor, and the temperature sensor disposed in the first battery using an existing algorithm.

In S4, the battery controller determines whether the voltage VA of the junction is higher than the open circuit voltage V_Pb.

When the determination result of S4 is YES, that is, when the voltage VA of the junction is higher than the open circuit voltage V_Pb, it is estimated that the first battery and the second battery can be simultaneously charged by turning on both of the first and second switches. That is, it is estimated that power is not discharged from the first battery maintained at a higher potential to the second battery even when both of the first and second switches are turned on. Therefore, when the determination result of S4 is YES, the battery controller starts simultaneous charging of the first and second batteries by turning on both of the first and second switches (see S5).

When the determination result of S4 is NO, that is, when the voltage VA of the junction is lower than the open circuit voltage V_Pb, it is estimated that power is discharged from the first battery to the second battery and the first battery cannot be charged when both of the first and second switches are turned on. Therefore, when the determination result of S4 is NO, the battery controller turns off the first switch, turns on the second switch, and starts preferential charging of the second battery such that discharging of the first battery during the regenerative power generation is prevented (see S6).

FIG. 4 is a flowchart illustrating a specific process flow of switch control. In S11, the battery controller determines whether both of the first and second switches are currently turned on.

When the determination result of S11 is YES, that is, when simultaneous charging of the first and second batteries is currently performed, the battery controller acquires a charging current I_Pb to the first battery which is one of parameters specifying a charging state of the first battery (see S12). The charging current I_Pb to the first battery can be acquired using an output of the current sensor disposed in the first battery.

In S13, the battery controller determines whether the acquired charging current I_Pb is equal to or less than a predetermined simultaneous charging end current I_th. Here, the simultaneous charging end current I_th is a threshold value which is set for the charging current I_Pb to determine a timing at which the simultaneous charging which is currently performed is ended and the preferential charging of the second battery is started, and is set to a positive value (for example, 1 [A]) slightly larger than zero. While the regenerative power generation is performed with deceleration of the vehicle, the generated current of the motor generator decreases gradually as the speed of the vehicle approaches zero. The charging current I_Pb to the first battery decreases and finally becomes negative as the generated current decreases, and the first battery is changed from charging to discharging. Therefore, by setting the simultaneous charging end current I_th to a positive value slightly larger than zero, the battery controller ends the simultaneous charging before the first battery is changed from charging to discharging.

When the determination result of S13 is NO (I_Pb>I_th), the battery controller determines that it is not time t0 end the simultaneous charging, and ends the process flow illustrated in FIG. 4 with both of the first and second switches turned on.

When the determination result of S13 is YES (I_Pb≤I_th), the battery controller determines that it is time t0 end the simultaneous charging, turns off the first switch with the second switch turned on, starts the preferential charging of the second battery (see S14), and ends the process flow illustrated in FIG. 4.

Then, when the determination result of S11 is NO, that is, when one of the first and second switches is currently turned off, the battery controller determines whether the first switch is turned off (see S15). When the determination result of S15 is NO, the battery controller ends the process flow illustrated in FIG. 4 without performing the processes of S16 to S21.

The case in which the determination result of S15 is YES refers to a state in which the first switch is turned off, the second switch is turned on, and the preferential charging of the second battery is currently performed. While the first switch is turned off, the first battery does not discharge power to the second battery, but may discharge power to other electric loads. For this reason, it is conceived that the SOC of the first battery decreases gradually. Therefore, when the determination result of S15 is YES, the battery controller estimates the current first SOC (see S16) and determines whether the first SOC is equal to or less than the first preferential SOC (see S17).

Here, the first SOC is the SOC of the first battery and can be estimated by searching a predetermined map using the open circuit voltage V_Pb of the first battery. The first preferential SOC is set between the first target SOC and the idling stop prohibition SOC as illustrated in FIG. 2. As described above, when the first SOC is less than the idling stop prohibition SOC in the idling stop state, the engine is restarted and the process of charging the first battery is performed. Therefore, when the regenerative power generation is being performed, the preferential charging of the second battery is being performed, and the first SOC is equal to or less than the first preferential SOC set to a value slightly larger than the prohibition SOC (when the determination result of S17 is YES), the battery controller first switches the second switch from ON to OFF (see S18) and then switches the first switch from OFF to ON (see S19). Accordingly, the preferential charging of the second battery is ended and the preferential charging of the first battery is started. Accordingly, it is possible to prevent unnecessary restarting of the engine due to the first SOC less than the prohibition SOC.

When the determination result of S17 is NO, the battery controller performs the process of S20. In S20, the battery controller acquires the open circuit voltage V_LiB of the second battery which is one of parameters specifying the charging state of the second battery and the open circuit voltage V_Pb of the first battery. Here, the open circuit voltages V_LiB and V_Pb of the batteries can be estimated based on the detected values of the voltage sensor, the current sensor, and the temperature sensor disposed in each battery using an existing algorithm.

In S21, the battery controller determines whether the open circuit voltage V_LiB of the second battery is greater than the open circuit voltage V_Pb of the first battery. When the determination result of S21 is YES, the battery controller determines that the second battery is sufficiently charged by the preferential charging of the second battery, first switches the second switch from ON to OFF (see S18), and then switches the first switch from OFF to ON (see S19). Accordingly, the preferential charging of the second battery is ended and the preferential charging of the first battery is started. When the determination result of S21 is NO, the battery controller ends the process flow illustrated in FIG. 4 with the first switch turned off and the second switch turned on such that the preferential charging of the second battery can be continuously performed.

In the power supply system S according to this embodiment, the following advantages can be obtained.

(1) In the power supply system S, the first and second batteries 2 and 5 are arranged in parallel to the motor generator 1, the first power supply line 34 that connects the second battery 5 and the motor generator 1 is connected to the first battery 2 via the first switch SW1, and the open circuit voltage of the first battery is set to be higher than the open circuit voltage of the second battery 5. In the power supply system S, when the regenerative power generation of the motor generator 1 is started, the first and second switches SW1 and SW2 are turned on and the simultaneous charging of the first and second batteries 2 and 5 is started. Accordingly, a generated current is supplied from the motor generator 1 to the first and second batteries 2 and 5 and thus the first and second batteries 2 and 5 are simultaneously charged. Here, when the simultaneous charging of the first and second batteries 2 and 5 is continuously performed, the first battery 2 having a higher potential is changed from charging to discharging. In the power supply system S, by turning off the first switch SW1 at the timing determined based on the charging state (more specifically, the charging current I_Pb to the first battery 2) of the first battery 2 while the simultaneous charging is being performed (see S13 and S14 in FIG. 4), the simultaneous charging can be switched to the preferential charging of the second battery 5 before the first battery 2 is changed from charging to discharging. Accordingly, it is possible to charge the first battery 2 to a certain extent while the second battery 5 is prevented from having a poor state of charge. Since an opportunity to drive the motor generator 1 using an engine while the vehicle is traveling and to forcibly charge the second battery 5 can be reduced by preventing the second battery 5 from having a poor state of charge, it is possible to improve fuel efficiency of the vehicle as a whole.

(2) In the power supply system S, the preferential charging of the first battery 2 is started by turning off the second switch SW2 and turning on the first switch SW1 at the timing determined based on the charging state (more specifically, the open circuit voltage V_LiB of the second battery 5) of the second battery 5 after the simultaneous charging is switched to the preferential charging of the second battery 5 (see S18 to S19 and S20 to S21 in FIG. 4). That is, in the power supply system S, the second battery 5 is preferentially charged and then the first battery 2 is charged when there is room to spare. Accordingly, when the regenerative power generation is prolonged, it is possible to additionally charge the first battery 2 while preferentially charging the second battery 5.

(3) The generated current in the regenerative power generation decreases with a decrease in the speed of the vehicle and a decrease in the rotation speed of the motor generator 1. Accordingly, the generated current decreases, the charging current to the first battery 2 decreases, and the first battery 2 is switched from charging to discharging. Therefore, in the power supply system S, when the charging current I_Pb to the first battery 2 becomes equal to or less than the predetermined simultaneous charging end current I_th while the simultaneous charging is being performed, it is possible to minimize discharging of the first battery 2 during the regenerative power generation by turning off the first switch SW1.

### Second Embodiment

A second embodiment of the invention will be described below with reference to the accompanying drawings.

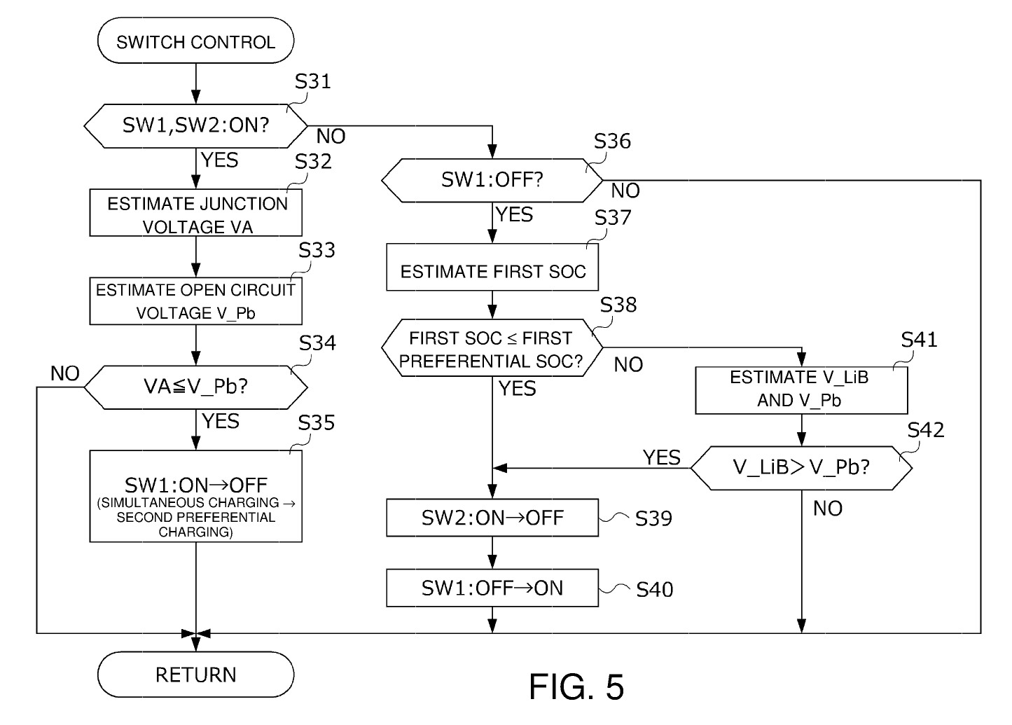

FIG. 5 is a flowchart illustrating a specific process flow of switch control in a power supply system according to this embodiment. The power supply system according to this embodiment is different from the power supply system according to the first embodiment, in that a voltage sensor that detects the voltage of the junction is additionally provided and a part of the specific process flow of the switch control is modified, and both are the same in the other configurations. The processes of S31 and S36 to S42 among the processes of S31 to S41 illustrated in FIG. 5 are the same as the processes of S11 and S15 to S21 illustrated in FIG. 4 and thus detailed description thereof will not be repeated.

When the determination result of S31 is YES, that is, when the simultaneous charging of the first and second batteries is currently performed, the battery controller acquires the current voltage VA of the junction using the voltage sensor (see S32).

In S33, the battery controller estimates the current open circuit voltage V_Pb of the first battery which is one of parameters specifying the charging state of the first battery. Here, the open circuit voltage V_Pb of the first battery can be estimated based on the detected values of the voltage sensor, the current sensor, and the temperature sensor which are disposed in the first battery using an existing algorithm.

In S34, the battery controller defines the current open circuit voltage V_Pb of the first battery as a simultaneous charging end voltage, and determines whether the voltage VA of the junction acquired in S32 is equal to or less than the simultaneous charging end voltage V_Pb. While the regenerative power generation is being performed due to the deceleration of the vehicle, the generated current by the motor generator decreases gradually as the speed of the vehicle approaches zero. The voltage VA of the junction in the simultaneous charging decreases with the decrease in the generated current and finally becomes lower than the open circuit voltage of the first battery, and the first battery is changed from charging to discharging. Therefore, by defining the simultaneous charging end voltage V_Pb which is the current open circuit voltage of the first battery as a threshold value for the voltage VA of the junction, the battery controller ends the simultaneous charging before the first battery is changed from charging to discharging.

When the determination result of S34 is NO (VA>V_Pb), the battery controller determines that it is not yet time t0 end the simultaneous charging and ends the process flow illustrated in FIG. 5 with both of the first and second switches turned on. When the determination result of S34 is YES (VA≤V_Pb), the battery controller determines that it is time t0 end the simultaneous charging, turns off the first switch with the second switch turned on, starts the preferential charging of the second battery (S35), and ends the process flow illustrated in FIG. 5.

In the power supply system according to this embodiment, the following advantages can be obtained.

(4) The generated current in the regenerative power generation decreases with a decrease in the speed of the vehicle and a decrease in the rotation speed of the motor generator 1. Accordingly, the generated current decreases, the voltage VA of the junction decreases, and the first battery 2 is switched from charging to discharging. Therefore, in the power supply system, when the voltage VA of the junction becomes equal to or lower than the simultaneous charging end voltage which is set to be equal to the open circuit voltage V_Pb of the first battery 2 at that time while the simultaneous charging is being performed, it is possible to minimize discharging of the first battery 2 during the regenerative power generation by turning off the first switch SW1.

### Third Embodiment

A third embodiment of the invention will be described below with reference to the accompanying drawings.

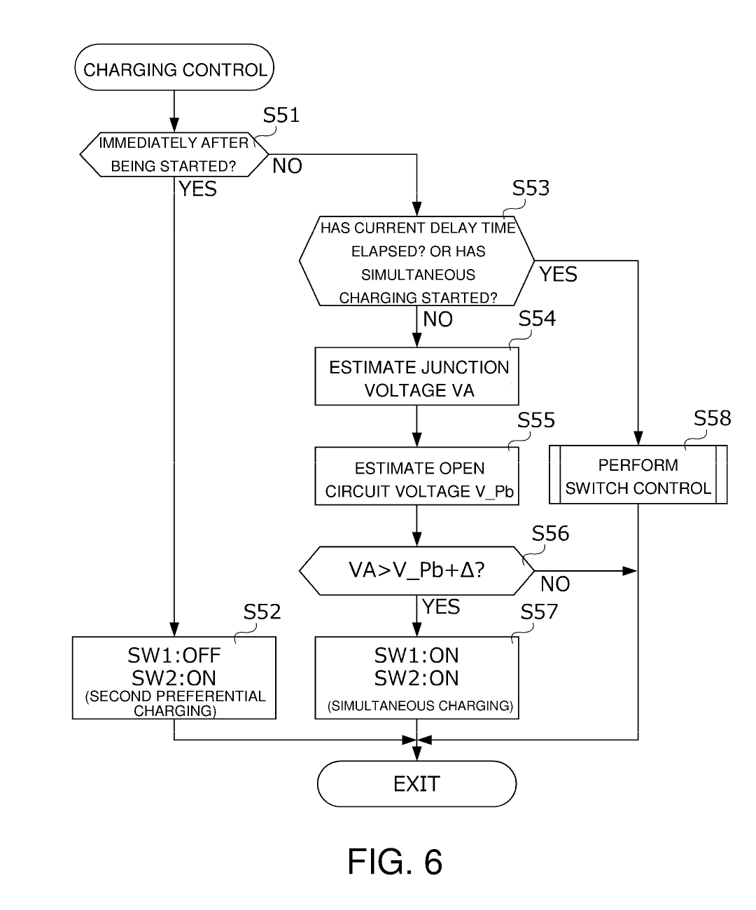

FIG. 6 is a flowchart illustrating a specific process flow of charging control the first and second batteries in a power supply system according to this embodiment. The power supply system according to this embodiment is different from the power supply system according to the first embodiment, in that a voltage sensor that detects the voltage of the junction is additionally provided and a part of the specific process flow of the charging control is modified, and both are the same in the other configurations.

In S51, the battery controller determines whether it is immediately after the regenerative power generation is started. When the determination result of S51 is YES, the battery controller turns on the second switch with the first switch turned off and starts the preferential charging of the second battery (see S52).

In the power supply system according to the first embodiment, the voltage VA of the junction is estimated immediately after the regenerative power generation is started, and the voltage VA of the junction is compared with the open circuit voltage V_Pb of the first battery to determine whether the simultaneous charging should be started (see S5 in FIG. 3) and whether the preferential charging of the second battery should be started (see S6 in FIG. 3). On the other hand, the power supply system according to this embodiment is different from the power supply system according to the first embodiment, in that the preferential charging of the second battery is started without estimating the voltage VA of the junction or the like.

When the determination result of S51 is NO, that is, when the process of S52 has been already performed and the initial states of the first and second switches have been determined, the battery controller determines whether a predetermined current delay time has elapsed after the regenerative power generation is started or whether the simultaneous charging of S57 which will be described later has been started in S53. The current delay time corresponds to a time required until an actual generated current reaches the target generated current after the motor generator has started the regenerative power generation.

When the determination result of S53 is NO, the battery controller acquires the voltage VA of the junction when the preferential charging of the second battery is performed using the voltage sensor (see S54).

In S55, the battery controller estimates the current open circuit voltage V_Pb of the first battery. Here, the open circuit voltage V_Pb of the first battery can be estimated based on the detected values of the voltage sensor, the current sensor, and the temperature sensor which are disposed in the first battery using an existing algorithm.

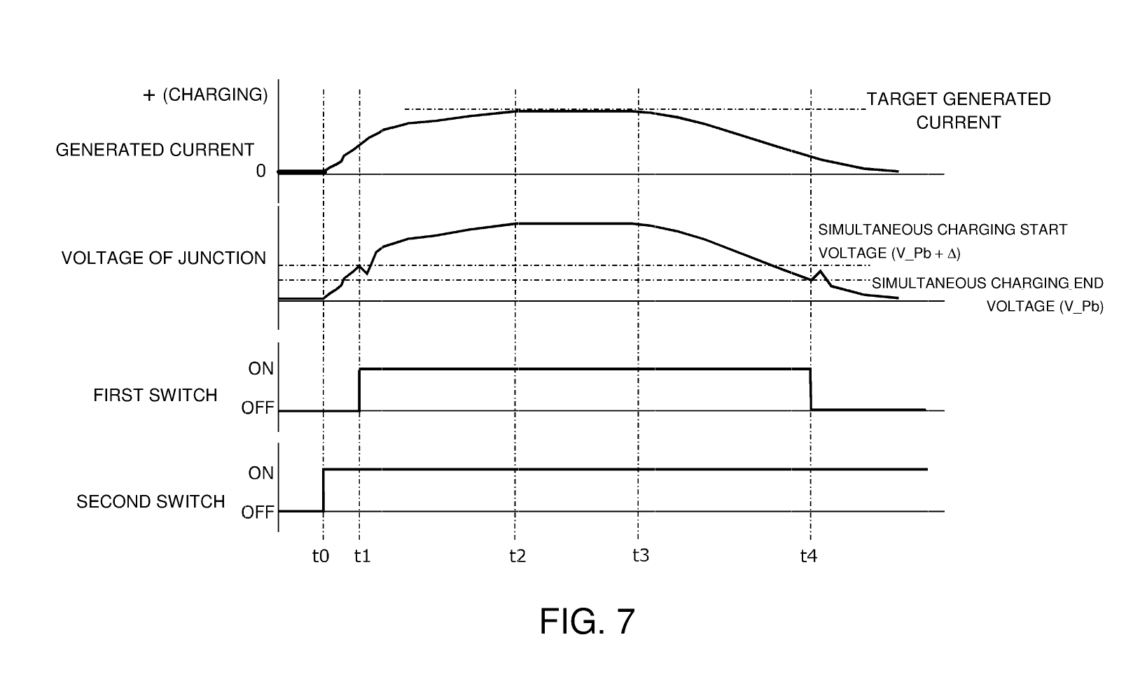

In S56, the battery controller determines whether the current voltage VA of the junction is higher than a simultaneous charging start voltage (V_Pb+Δ) which is defined by adding a predetermined margin Δ to the current open circuit voltage V_Pb. The margin Δ is determined to prevent haunting of the first switch and has a positive value slightly larger than zero, as will be described later with reference to FIG. 7.

When the determination result of S56 is YES, the voltage VA of the junction is higher than the simultaneous charging start voltage. Accordingly, it is estimated that the first battery and the second battery can be simultaneously charged by turning on both of the first and second switches. That is, it is estimated that discharging from the first battery, which is maintained at a higher potential, to the second battery does not occur even when both of the first and second switches are turned on. Therefore, when the determination result of S56 is YES, the battery controller turns on both of the first and second switches and starts the simultaneous charging of the first and second batteries (see S57).

When the determination result of S56 is NO, the voltage VA of the junction is equal to or lower than the simultaneous charging start voltage. Accordingly, it is estimated that, when both of the first and second switches are turned on, power is discharged from the first battery to the second battery and the first battery cannot be charged. Therefore, when the determination result of S56 is NO, the battery controller continues to perform the preferential charging of the second battery.

When the determination result of S53 is YES, that is, when it is determined that the simultaneous charging of S57 has been already started or the actual generated current reaches the target generated current, the battery controller performs switch control in S58. Here, in S58, the switch control in the power supply system according to the first embodiment illustrated in FIG. 4 may be performed or the switch control in the power supply system according to the second embodiment illustrated in FIG. 5 may be performed. In the following description, a case in which the switch control illustrated in FIG. 5 is performed in S58 will be described.

FIG. 7 is a timing chart of the charging control illustrated in FIG. 6. In FIG. 7, the generated current of the motor generator, the voltage of the junction, the state of the first switch, and the state of the second switch are illustrated sequentially from the upper portion. In FIG. 7, a case in which the vehicle decelerates at time t0 and the regenerative power generation by the motor generator is started is illustrated.

At time t0, with the start of the regenerative power generation by the motor generator, the battery controller turns on the second switch with the first switch turned off and starts the preferential charging of the second battery (see S52 in FIG. 6). After time t0, the generated current of the motor generator starts increasing to the target generated current and the voltage of the junction increases accordingly, and the second battery is charged with the generated current.

Thereafter, at time t1, the voltage VA of the junction reaches the simultaneous charging start voltage which is obtained by adding the margin Δ to the open circuit voltage V_Pb of the first battery at this time, and thus the battery controller switches the first switch from OFF to ON with the second switch turned on and starts the simultaneous charging of the first and second batteries. Accordingly, the generated current is supplied to both of the first battery and the second battery and both batteries are charged.

Thereafter, at time t2, the actual generated current reaches the target generated current. After time t3, with a decrease in the vehicle speed, the generated current decreases gradually and thus the voltage VA of the junction also decreases.

At time t4, the voltage VA of the junction decreases to be equal to or lower than the simultaneous charging end voltage which is set to the same value as the open circuit voltage V_Pb of the first battery at that time. Accordingly, at time t4, the battery controller turns off the first switch (see S35 in FIG. 5) and performs the preferential charging of the second battery again, such that the first battery is prevented from being changed from charging to discharging due to the decrease in the voltage of the junction.

The reason why a difference of the margin Δ is provided between the simultaneous charging start voltage and the simultaneous charging end voltage will be described below. As illustrated in FIG. 7, the voltage VA of the junction decreases slightly by turning on the first switch at time t1 and increases slightly by turning off the first switch at time t4. In the process of S34 in FIG. 5 or the process of S56 in FIG. 6, the first switch is switched between ON and OFF by comparing the voltage VA of the junction with the open circuit voltage V_Pb of the first battery. However, since the voltage VA of the junction increases or decreases slightly by turning on or off the first switch, there is concern that the first switch will be haunted between ON and OFF when the simultaneous charging start voltage and the simultaneous charging end voltage are set to the same value. Accordingly, in the power supply system according to this embodiment, the margin Δ is set between the simultaneous charging start voltage and the simultaneous charging end voltage.

In the power supply system according to this embodiment, the following advantages are obtained.

(5) In the power supply system, the regenerative power generation is started while the first switch SW1 is turned off and the second switch SW2 is turned on (see S52 in FIG. 6), and the preferential charging of the second battery 5 is started. Accordingly, a generated current is supplied from the motor generator 1 to the second battery 5 and thus the second battery 5 is charged. At this time, in the power supply system, the voltage VA of the junction and the open circuit voltage V_Pb of the first battery 2 are acquired, and the first switch SW1 is turned on and the simultaneous charging of the first and second batteries 2 and 5 is performed at the timing at which the voltage VA of the junction exceeds the simultaneous charging start voltage obtained by adding a margin Δ to the open circuit voltage V_Pb of the first battery 2 while the generated current is supplied to the second battery 5 (see S56 to S57 in FIG. 6). In a case in which the first and second batteries 2 and 5 are connected to the motor generator 1 and the simultaneous charging thereof is performed, the first battery 2 may not be charged but may be discharged even by turning on the first switch SW1 when the generated current from the motor generator 1 is small and the voltage VA of the junction is lower than the open circuit voltage V_Pb of the first battery 2. In the power supply system, at the time of the regenerative power generation, it is possible to start the simultaneous charging while preventing discharging of the first battery 2 by preferentially charging the second battery 5 and then determining the timing at which the simultaneous charging is started using the voltage VA of the junction and the open circuit voltage V_Pb of the first battery 2. Accordingly, it is possible to charge the first battery 5 to a certain extent while the second battery 5 is prevented from having a poor state of charge.

While embodiments of the invention have been described above, the invention is not limited to the embodiments. Detailed configurations may be appropriately modified without departing from the gist of the invention.

What is claimed is:

1. A power supply system for a vehicle comprising a power generator capable of performing regenerative power generation when a vehicle decelerates, a first power storage device and a second power storage device connected in parallel to the power generator, and a first switch for connecting or disconnecting a charging circuit in which the second power storage device and the power generator are connected to or from the first power storage device, wherein an open circuit voltage of the first power storage device is controlled to be higher than an open circuit voltage of the second power storage device, the power supply system comprising:
a charging control unit configured to turn on the first switch and to start simultaneous charging of the first power storage device and the second power storage device when the regenerative power generation of the power generator is started; and
a first charging state monitoring unit configured to acquire a charging state of the first power storage device while the regenerative power generation is being performed,
wherein the charging control unit turns off the first switch and starts preferential charging of the second power storage device at a timing determined based on the charging state acquired by the first charging state monitoring unit after the simultaneous charging is started.

2. The power supply system for a vehicle according to claim 1, further comprising:
a second charging state monitoring unit configured to acquire a charging state of the second power storage device while the regenerative power generation is being performed; and
a second switch disposed closer to the second power storage device than a junction connected to the first power storage device in the charging circuit and configured to connect or disconnect the second power storage device and the power generator,
wherein the charging control unit starts preferential charging of the first power storage device by turning off the second switch at a timing determined based on the charging state acquired by the second charging state monitoring unit and then turning on the first switch after the preferential charging of the second power storage device is started.

3. The power supply system for a vehicle according to claim 1, wherein the first charging state monitoring unit acquires a charging current in the first power storage device while the regenerative power generation is being performed as a parameter indicating the charging state of the first power storage device, and
wherein the charging control unit turns off the first switch and starts the preferential charging of the second power storage device when the charging current acquired by the first charging state monitoring unit becomes equal to or less than a predetermined simultaneous charging end current after the simultaneous charging is started.

4. The power supply system for a vehicle according to claim 1, wherein the first charging state monitoring unit acquires the open circuit voltage of the first power storage device as a parameter indicating the charging state of the first power storage device, and
wherein the charging control unit turns off the first switch and starts the preferential charging of the second power storage device when a voltage of the junction connected to the first power storage device in the charging circuit is equal to or lower than the open circuit voltage of the first power storage device acquired by the first charging state monitoring unit after the simultaneous charging is started.

5. A power supply system for a vehicle comprising a power generator capable of performing regenerative power generation when a vehicle decelerates, a first power storage device and a second power storage device connected in parallel to the power generator, and a first switch for connecting or disconnecting a charging circuit in which the second power storage device and the power generator are connected to or from the first power storage device, wherein an open circuit voltage of the first power storage device is controlled to be higher than an open circuit voltage of the second power storage device, the power supply system comprising:
a charging control unit configured to start regenerative power generation of the power generator while turning off the first switch and to start preferential charging of the second power storage device;
a junction voltage monitoring unit configured to acquire a voltage of a junction connected to the first power storage device in the charging circuit while the regenerative power generation is being performed; and
a first voltage monitoring unit configured to acquire the open circuit voltage of the first power storage device while the regenerative power generation is being performed,
wherein the charging control unit turns on the first switch and starts simultaneous charging of the first power storage device and the second power storage device at a timing determined based on the voltage of the junction acquired by the junction voltage monitoring unit and the open circuit voltage of the first power storage device acquired by the first voltage monitoring unit after the preferential charging of the second power storage device is started.

6. The power supply system for a vehicle according to claim 5, wherein the charging control unit turns off the first switch when the voltage of the junction acquired by the junction voltage monitoring unit is equal to or lower than the open circuit voltage of the first power storage device acquired by the first voltage monitoring unit while the regenerative power generation is being performed and the first switch is turned off.
